(19) United States
(12) Patent Application Publication
(10) Pub. No.: US 2009/0298543 A1
(43) Pub. Date: Dec. 3, 2009

(54) CHIP CARD WITH COMPLEMENTARY ELECTRONIC MEANS

(75) Inventor: Michel WILLEMIN, Preles (CH)

Correspondence Address: SUGHRUE MION, PLLC, 2100 PENNSYLVANIA AVENUE, N.W., SUITE 800, WASHINGTON, DC, 20037, US

(73) Assignee: EM Microelectronic-Marin S.A., Marin (CH)

(21) Appl. No.: 12/466,787

(22) Filed: May 15, 2009

(30) Foreign Application Priority Data
May 29, 2008 (CH) 00822/08

(51) Int. Cl. H04B 1/38

(52) U.S. Cl. 455/558

(57) ABSTRACT

The chip card includes at least one integrated circuit (11) provided with a memory unit, which stores personal data and some configuration parameters. The integrated circuit is enclosed in an insulating material that forms said card. The chip card may also include connecting means, such as a zone of accessible electric contacts (V_{CC}, GND) on at least one surface of the card, for contact with complementary contact terminals of an electronic instrument. These electric contacts are electrically connected to corresponding contact pads of the integrated circuit. The chip card may be a memory card or a SIM card. The chip card also includes a measuring circuit with a sensor (C) for measuring a physical parameter so as to provide at least one output signal relating to the physical parameter measurement (S_{D}) by one of the electric contacts (I/O).

This application claims priority from Swiss Patent Application No. 00822/08 filed May 29, 2008, the entire disclosure of which is incorporated herein by reference.

### FIELD OF THE INVENTION

The invention concerns a chip card, such as a SIM card, which includes at least one integrated circuit provided with a memory unit, which can store personal data and/or at least one chip card identification code and/or configuration parameters. The integrated circuit is enclosed or encapsulated in an opaque insulating material that forms the card. The chip card also includes connecting means for communicating with an electronic instrument in which said chip card could, for example, be placed. These connecting means are electrically connected to corresponding contact pads of the integrated circuit.

“Connecting means” essentially means any means for communicating data and/or commands with an electronic instrument. These connecting means can, for example, be a zone of accessible electric contacts on at least one surface of the chip card. The electric contacts of said contact zone will come into contact with complementary contact terminals of an electronic instrument in which said chip card can be placed.

### BACKGROUND OF THE INVENTION

The chip card may be, for example, a SIM card or a memory card or a credit card in a format that enables said cards to be placed in an electronic instrument, which could be for example a mobile (cellular) telephone. In the case of a telecommunications instrument, such as a mobile telephone, the chip card could preferably be a SIM card, which is adapted for insertion into a housing provided inside said telephone and connected to contact terminals of the telephone. In a GSM type cellular network, the use of this chip card in the electronic instrument, particularly in the mobile telephone, ensures user identification via a telecommunications system operator. The chip card also ensures the compatibility and interchangeability of mobile telephones within this telecommunications system.

These chip cards allow the user to access the mobile telecommunications system via an appropriate network provider or operator. They therefore include data, which defines the modes of access to the mobile telecommunications system and allows complementary data to be stored relating to the user. This complementary data concerns for example a personal identification number and/or a directory of telephone call numbers.

The dimensions and physical features of each SIM chip card (Subscriber Identity Module) are defined by international standards, such as, in particular, ISO/IEC standards 7810, 7816-1 and 7816-2. This type of chip card thus takes the form of a plastic card that houses at least one integrated circuit. There are two standard chip card formats for integration into a portable electronic instrument. The first format is comparable to that of a credit card (85.6 mm×53.98 mm×0.8 mm). The second format has smaller dimensions of the order of 25 mm×15 mm×0.8 mm, like the example illustrated in FIG. 1 and described in the following description.

It is also known to fit this type of SIM chip card with electronic means, such as an RFID device, for two-directional data communication by means of an antenna of the RFID device, which is housed in the chip card. US Patent Application No. 2007/0281549, which mentions this RFID function in connection with said chip card integrated circuit, may be cited in this regard. However, this type of RFID device only has similar functions to those connected to telephony.

In the DE Patent No. 199 55 120, it is also described a chip card, which includes an integrated circuit with a memory intended to store identification data of a product and to allow reading of stored data. The integrated circuit is connected to one or several sensors able to provide data relative to environmental conditions. One of sensors can be an accelerometer or a temperature sensor. Data provided, for example, by the accelerometer, is stored in the memory in order to be read and used passively afterwards by a reading apparatus. Data provided by the accelerometer are not actively exploited for controlling directly an action or a function of an electronic instrument, in which the card can be placed.

### SUMMARY OF THE INVENTION

It is therefore an object of the invention to provide a chip card that includes complementary electronic means for performing different functions from those of the conventional chip card integrated circuit and able to be used for controlling directly an action or a function of an electronic instrument.

The invention thus concerns the aforecited chip card, which includes at least one integrated circuit provided with a memory unit, in which personal data and/or at least one chip card identification code and/or configuration parameters can be stored, said integrated circuit being enclosed in an insulating material that forms said card, the card also including connecting means for communicating with an electronic instrument, said connecting means being electrically connected to corresponding contact pads of the integrated circuit, the chip card further including a measuring circuit with a sensor for measuring a physical parameter so as to be able to supply at least one output signal relating to the measurement of the physical parameter, wherein the measuring circuit with a sensor includes a movement sensor for detecting a shock or for measuring an acceleration, and a sensor interface connected to the sensor, for providing a measurement signal for the physical parameter to measurement signal pre-processing means such that the pre-processing means supply an output signal relating to the parameter measurement that can be exploited directly in an active manner for commanding an action or function of an electronic instrument.

One advantage of the chip card, such as a SIM card, is that, once inserted in and connected to a portable instrument, such as a mobile telephone, it can supply data and/or control signals on the basis of at least one measurement carried out by the measuring circuit containing a sensor.

In the preferable case of a movement sensor, such as an acceleration or shock sensor, a command can be provided directly to the portable electronic instrument or via the integrated circuit of said card. This command relating to the detected movement allows the instrument to recognise actions or functions to be performed that are pre-programmed by the user. For example, one could envisage a specific function being executed in the instrument via a single acceleration or shock or pulse imparted to the chip card, or several shocks or pulses in succession imparted to the chip card.

Advantageously, one could also envisage with this movement sensor measuring circuit providing a digital output measuring signal, which could be stored in a dedicated register of the integrated circuit memory unit. This output signal can control the portable instrument for recognition of models, menus, movements of the person carrying the instrument, shocks experienced by the instrument, or for drawing. In order to do this, the sensor measuring circuit may preferably be an accelerometer or pedometer that uses measurement of a capacitive variation in the differential mounted capacitors of a capacitive sensor. This accelerometer may also be a triaxial accelerometer, which can provide commands to the portable instrument, for example for remotely activating a mechanical machine, such as a robot or a vehicle.

One advantage of said chip card mounted in the portable instrument is that, if the chip card includes an accelerometer, the acceleration measurement can command the portable instrument to change, for example, from low consumption mode or standby to normal operating mode.

If the chip card is a SIM card or a memory card, all of the parameters linked to the measuring circuit, in particular the configuration parameters, can be stored. These configuration parameters may be personal to the chip card user. This means that the portable instrument, such as the mobile telephone, in which said chip card is placed, can be changed, while keeping all the parameters stored, and without having to repeat configuration each time that the instrument is changed. These parameters can be stored in a memory that is directly provided in the measuring circuit or in the integrated circuit memory unit.

The chip card can advantageously include its own electric power means. These electric power means can include a solar cell or an energy accumulator or RFID device for picking up radio-frequency signals.

The invention thus also concerns an electronic instrument including a chip card, wherein the measuring circuit of the chip card is provided for supplying a control output signal on the basis of one single or several successive accelerations or shocks to the movement sensor of said chip card, the control signal commanding a pre-programmed action or function to be executed directly in an active manner in the electronic instrument.

### BRIEF DESCRIPTION OF THE DRAWINGS

The objects, advantages and features of the chip card will appear more clearly in the following, non-limiting description of at least one embodiment, illustrated by the drawings, in which:

FIG. 1 shows a top view of a chip card in the form of a SIM card according to the invention for a mobile telephone, and

FIG. 2 shows in a simplified manner the electronic components of the chip card according to the invention.

### DETAILED DESCRIPTION OF THE INVENTION

In the following description, all those parts of the chip card, which are well known to those skilled in the art in this technical field, are related only in a simplified manner.

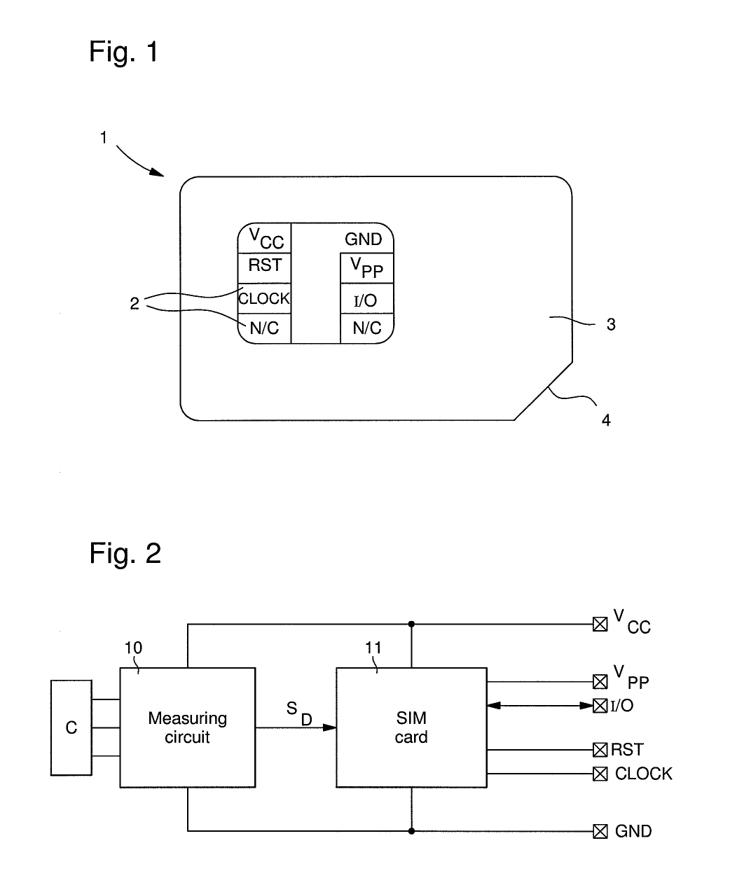

FIG. 1 shows a chip card or smart card in the form of a conventional SIM card 1. The main features of this SIM card 1, which can be used in a mobile telephone according to the present invention are thus briefly described.

This SIM card 1 takes the form of a flat, essentially rectangular element with dimensions of the order, for example, of 15 mm×25 mm and a thickness of close to 0.76 mm. SIM card 1 includes, in particular, an oblique edge 4 used as a polarizing slot for orienting the card properly when it is inserted in a housing in the telephone provided for that purpose.

SIM card 1 also includes connecting means 2 for communicating, in particular, data and/or commands to an electronic instrument, such as a mobile telephone in which said SIM card is placed. These connecting means may preferably be a zone of accessible electric contacts 2, which are arranged over at least one surface of said chip card. Electric contacts 2 are shown as being eight in number, but only six of these contacts are generally used. Electric contacts 2 are connected in a conventional manner to corresponding contact pads on an integrated circuit that is not shown. This integrated circuit is thus enclosed in the opaque insulating material 3 that forms said chip card.

Electric contact zone 2 is arranged on one surface of the chip card in accordance with international standards as indicated above. Once the chip card has been inserted in the housing of a mobile telephone, the electric contacts of contact zone 2 are connected to complementary contact terminals provided in a well-defined position in the telephone. Electric power can be provided by the telephone to the card via two electric contacts V_{CC} and GND of contact zone 2. The following may also be provided: an electric contact RST for receiving a Reset signal, an electric contact V_{PP} for receiving a programming voltage signal from the memory unit, an electric contact CLOCK for receiving or supplying a clock signal and an electric signal I/O for receiving or transferring data or commands.

As shown schematically in FIG. 2, said integrated circuit 11 for a SIM type card generally includes a memory unit, not shown, which is connected to a microprocessor unit, not shown, for processing received or transmitted data or commands. The memory unit can include a Flash or EEPROM type non-volatile memory for storing personal data, at least one chip card identification code and configuration parameters. The memory unit also contains data defining access modes to the mobile telecommunications system.

The chip card according to the invention further includes a measuring circuit 10 with a sensor C, which is also enclosed in the opaque insulating material forming said chip card. This measuring circuit can include a movement sensor C for detecting a shock or mainly measuring an acceleration. A single axis or triaxial pedometer or accelerometer may thus be used as a measuring circuit with a sensor. This movement sensor C can thus advantageously be an element in the form of a MEMS type module.

One could envisage using an accelerometer, which includes two differential mounted capacitors to form a capacitive sensor whose capacitive variation is measured by a sensor interface of the measuring circuit. The measuring circuit sensor interface can be made, for example, on the basis of an electronic interface as described, in particular, in the article by Messrs. H. Leutold and F. Rudolph, which appeared in the review entitled “Sensors and Actuators” A21-23 (1990), pages 278 to 281. A piezo-resistive accelerometer can also be used.

This sensor interface supplies a measuring signal for the physical parameter (acceleration) to means for pre-processing the measuring signal, so that the means supply a digital output signal S_{D} relating to the parameter measurement. This output signal can be exploited directly or via the integrated SIM circuit 11, to control an action or function of a portable instrument, such as a mobile telephone. This allows a rapid command to be performed in the telephone.

In the preferred case of a movement sensor, for measuring acceleration or a shock, a command can be supplied to the portable electronic instrument directly or via the integrated circuit of said card. This command relating to the detected movement can enable the instrument to recognise actions or functions to be performed that are pre-programmed by the user. One could envisage executing a specific function in the instrument via a single shock or pulse imparted to the chip card or several successive pulses imparted to the chip card in a defined period of time.

This digital output signal S_{D} can be stored in a measuring circuit memory or preferably in a dedicated register of the memory unit of the SIM integrated circuit 11. Reading of this stored digital signal remains flexible over time depending upon the user. Said stored output signal may be required to be read at any time. This memory unit can also store measuring circuit configuration parameters, personal to a chip card user, and/or different successive measuring circuit output signals. In this manner, a number of personal data or configurations are stored in the memory of measuring circuit 10 or in the memory unit of SIM circuit 11. The chip card can thus be placed in any other portable instrument, i.e. in any other mobile telephone without all of the personal command or data programming or storage operations having to be repeated.

After the sensor interface, the sensor measuring circuit may include, as pre-processing means, another processing unit for analogue signals, an analogue-digital converter, a digital signal control and processing unit, an oscillator and a regulated voltage regulator for powering the electronic components of the measuring circuit at a regulated voltage. The digital output signal S_{D} can thus be provided by the control and processing unit so that it can be stored in a dedicated register in the SIM circuit memory unit. This arrangement of the measuring circuit electronic components is disclosed in CH Patent Application No. 01431/07 by the same Applicant, which is incorporated here by reference.

In a first embodiment of the chip card, the measuring circuit, without the sensor, can be made in the integrated circuit of the chip card SIM circuit. The measuring sensor C may be a micro-electro-mechanical element (MEMS), which is electrically connected to the measuring circuit sensor interface. This measuring sensor may be mounted on the integrated circuit while ensuring that the total thickness is less than the thickness of the opaque material of the chip card that encloses it. However, the sensor may also be placed in the same plane as said integrated circuit.

In a second embodiment of the chip card, one could also envisage making the measuring circuit with the measuring sensor in the same semiconductor substrate as the chip card integrated circuit.

In a third embodiment of the chip card, the measuring circuit, without the sensor, is made in a second integrated circuit and electrically connected to the first chip card integrated circuit. The first and second integrated circuits can be placed side-by-side in the chip card insulating material. The MEMS sensor, which is electrically connected to the measuring circuit sensor interface, can be mounted on the second integrated circuit, or placed in the same plane as said second integrated circuit.

One could also envisage the chip card also including its own electric power means (stand-alone mode). A solar cell or an electric energy accumulator or a RFID device could form these electric power means. Several integrated circuits could also be mounted in the same chip card or several measuring circuits with sensors in the same chip card for measuring other physical parameters, such as pressure and/or temperature.

From the description that has just been given, those skilled in the art can devise several alternative embodiments of the chip card without departing from the scope of the invention defined by the claims. In the case of the chip card in the form of a memory card, the electric contact zone could be on one edge of said card with part of the electric contacts located on at least one main surface of the card. The chip card connecting means could also be a wireless connecting device, such as a RFID device or a light transmission/reception device. Inside the opaque material that encloses the integrated circuit(s), a housing could be provided for the sensor, depending upon the type of physical parameter to be measured.

1. A chip card which includes at least one integrated circuit provided with a memory unit, in which personal data and/or at least one chip card identification code and/or configuration parameters can be stored, said integrated circuit being enclosed in an insulating material that forms said card, the card also including connecting means for communicating with an electronic instrument, said connecting means being electrically connected to corresponding contact pads of the integrated circuit, the chip card further including a measuring circuit with a sensor for measuring a physical parameter so as to be able to supply at least one output signal relating to the measurement of the physical parameter, wherein the measuring circuit with a sensor includes a movement sensor for detecting a shock or for measuring an acceleration, and a sensor interface connected to the sensor, for providing a measurement signal for the physical parameter to measurement signal pre-processing means such that the pre-processing means supply an output signal relating to the parameter measurement that can be exploited directly in an active manner for commanding an action or function of an electronic instrument.

2. The chip card according to claim 1, wherein the connecting means include a wireless connection device and/or an accessible electric contact zone on at least one surface of the card that comes into contact with complementary contact terminals of an electronic instrument in which said chip card can be placed, said electric contacts being electrically connected to corresponding contact pads of the integrated circuit, and wherein the measuring circuit with the sensor for measuring a physical parameter can supply at least one output signal relating to the measurement of the physical parameter via the wireless connection device and/or by one of the electric contacts of the contact zone.

3. The chip card according to claim 1, wherein the measuring circuit with a sensor is a triaxial accelerometer.

4. The chip card according to claim 1, wherein the chip card is a SIM card that can be placed in the electronic instrument, which is a mobile telephone, and wherein the measuring circuit interface is provided on the basis of one single or several successive accelerations or shocks to said chip card, to supply a signal for commanding the execution of a pre-programmed action or function in the electronic instrument.

5. The chip card according to claim 1, wherein at least one dedicated register in the integrated circuit memory unit is provided for storing the output signal relating to measurement of the measuring circuit parameter.

6. The chip card according to claim 1, wherein measuring circuit configuration parameters, peculiar to a chip card user, and/or different successive output signals from the measuring circuit, are stored in a memory unit of the integrated circuit.

7. The chip card according to claim 1, wherein the measuring circuit includes a movement sensor and a pressure and/or temperature sensor, which can be switched on alternately.

8. The chip card according to claim 4, wherein, in addition to the memory unit, the SIM card includes a microprocessor unit for processing data or commands received or transmitted by the means for connection to an electronic instrument, such as a mobile telephone, in which said chip card can be placed.

9. The chip card according to claim 1, wherein the measuring circuit without the sensor is made in an integrated circuit of the chip card, and in that the sensor is a micro-electro-mechanical element, which is electrically connected to a sensor interface of the measuring circuit.

10. The chip card according to claim 1, wherein the measuring circuit with the sensor is made in the same semiconductor substrate as the chip card integrated circuit.

11. The chip card according to claim 1, wherein the measuring circuit without the sensor is made in a second integrated circuit and electrically connected to the first integrated circuit of the chip card, the first and second integrated circuits being placed side by side in the insulating material of the chip card, and wherein the sensor is a micro-electro-mechanical element, which is electrically connected to a sensor interface of the measuring circuit.

12. The chip card according to claim 9, wherein the sensor is mounted on the integrated circuit that includes the measuring circuit.

13. The chip card according to claim 1, wherein it includes means for electrically powering the chip card components, such as a solar cell or an electric energy accumulator.

14. The electronic instrument including a chip card according to claim 1, wherein the measuring circuit of the chip card is provided for supplying a control output signal on the basis of one single or several successive accelerations or shocks to the movement sensor of said chip card, the control signal commanding a pre-programmed action or function to be executed directly in an active manner in the electronic instrument.

15. The electronic instrument according to claim 14, wherein it is a mobile telephone, and in that the chip card is a SIM card, whose measuring circuit with a sensor is used for executing an action or function that is not a telephonic function.
